(19) United States
(12) Patent Application Publication
(10) Pub. No.: US 2013/0234498 A1
(43) Pub. Date: Sep. 12, 2013

(54) Wheel Cover and Method for Making and Packaging It

(71) Applicant: Ming-Fang Wang, Tainan City (TW)

(72) Inventor: Ming-Fang Wang, Tainan City (TW)

(21) Appl. No.: 13/413,720

(22) Filed: Mar. 7, 2012

(51) Int. Cl. B60B 7/06; B26D 7/27; B21D 53/32

(52) U.S. Cl. 301/37.102; 29/894.38; 53/396

(57) ABSTRACT

A wheel cover and a method for making and packaging it are disclosed. The wheel cover includes a main body (1), and a plurality of locking members (13). Each of the locking members is formed integrally on the inner face of the main body. Each of the locking members has a first end provided with a support portion (134) connected with the main body and a second end provided with a retaining portion (133). Thus, the support portion of each of the locking members is bendable relative to the main body so as to reduce a whole height of each of the locking members relative to the main body.

### BACKGROUND OF THE INVENTION

1. Field of the Invention

The present invention relates to a wheel cover and, more particularly, to a wheel cover and a method for making and packaging it.

2. Description of the Related Art

A conventional wheel cover 100 in accordance with the prior art shown in FIG. 1 comprises a main body 101, a plurality of locking members 102 connected with the main body 101, and a metallic ring (not shown) locked onto and held by the locking members 102. However, each of the locking members 102 has a fixed length and cannot be bent to reduce its length so that when multiple wheel covers 100 are stacked during packaging, the locking members 102 are located between the main bodies 101 of any two adjacent wheel covers 100 to largely increase the whole stacking height of the wheel covers 100 and to largely increase the packaging volume of the wheel covers 100, thereby causing inconvenience in and increasing the cost of packaging, storage and transportation of the wheel covers 100.

### BRIEF SUMMARY OF THE INVENTION

In accordance with one aspect of the present invention, there is provided a wheel cover, comprising a main body, and a plurality of locking members connected with the main body. The main body has an outer face directed outward in packaging and an inner face directed inward in packaging. The outer face of the main body has a surface provided with a plurality of through holes each having a predetermined pattern. Each of the locking members is formed integrally on the inner face of the main body. Each of the locking members has a first end provided with a support portion connected with the inner face of the main body. The support portion of each of the locking members is bendable relative to the inner face of the main body to reduce a whole length of each of the locking members. Each of the locking members has a second end provided with a retaining portion. Thus, the support portion of each of the locking members is bendable relative to the inner face of the main body to move the retaining portion of each of the locking members toward the inner face of the main body so as to reduce a whole height of each of the locking members relative to the inner face of the main body.

In accordance with another aspect of the present invention, there is provided a method for making a wheel cover, comprising forming a main body which has an outer face directed outward in packaging and an inner face directed inward in packaging, forming the outer face of the main body with a plurality of through holes each having a predetermined pattern, forming a plurality of locking members integrally on the inner face of the main body, with each of the locking members having a first end provided with a support portion connected with the inner face of the main body and a second end provided with a retaining portion, and bending the support portion of each of the locking members to move the retaining portion of each of the locking members toward the inner face of the main body so as to reduce a whole height of each of the locking members relative to the inner face of the main body.

In accordance with a further aspect of the present invention, there is provided a method for packaging multiple wheel covers, comprising forming a plurality of wheel covers each including a main body which has an outer face directed outward in packaging and an inner face directed inward in packaging, forming the outer face of the main body of each of the wheel covers with a plurality of through holes each having a predetermined pattern, forming a plurality of locking members integrally on the inner face of the main body of each of the wheel covers, with each of the locking members having a first end provided with a support portion connected with the inner face of the main body of each of the wheel covers and a second end provided with a retaining portion, bending the support portion of each of the locking members to move the retaining portion of each of the locking members toward the inner face of the main body of each of the wheel covers so as to reduce a whole height of each of the locking members relative to the inner face of the main body of each of the wheel covers, and stacking the wheel covers in a vertical manner.

According to the primary advantage of the present invention, each of the locking members is bendable relative to the main body so as to reduce the whole height of each of the locking members relative to the main body.

According to another advantage of the present invention, when multiple wheel covers are stacked, each of the locking members is bent to reduce the whole length of each of the locking members so that the distance between the main bodies of any two adjacent wheel covers is shortened so as to largely reduce the whole stacking height of the wheel covers and to largely reduce the packaging volume of the wheel covers, thereby facilitating and decreasing the cost of packaging, storage and transportation of the wheel covers.

According to a further advantage of the present invention, each of the locking members and the main body are formed integrally by a plastic injection molding process so as to decrease the cost of fabrication and assembly of the wheel cover.

According to a further advantage of the present invention, the locking members are not connected with the through holes of the main body so that the through holes of the main body will not be restricted by the locking members and can have different patterns, thereby enhancing the aesthetic quality of the wheel cover.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a front view showing a stacking state of a plurality of conventional wheel covers in accordance with the prior art.

FIG. 2 is a perspective view of a wheel cover in accordance with the preferred embodiment of the present invention.

FIG. 3 is a partially perspective bottom view of the wheel cover as shown in FIG. 2.

FIG. 4 is a perspective view of a locking member of the wheel cover as shown in FIG. 2.

FIG. 5 is a locally perspective enlarged view of the locking member of the wheel cover as shown in FIG. 4.

FIG. 6 is a perspective bent view of the locking member of the wheel cover as shown in FIG. 4.

FIG. 7 is a front folded view of the wheel cover as shown in FIG. 2.

FIG. 8 is a front view showing a stacking state of a plurality of wheel covers in accordance with the preferred embodiment of the present invention.

FIG. 9 is a perspective view of a locking member of the wheel cover in accordance with another preferred embodiment of the present invention.

FIG. 10 is a perspective bent view of the locking member of the wheel cover as shown in FIG. 9.

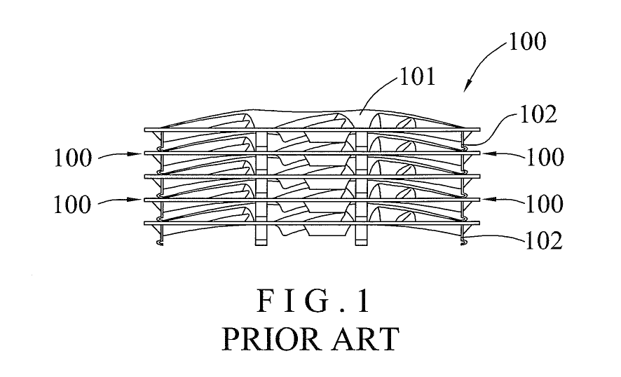

### DETAILED DESCRIPTION OF THE INVENTION

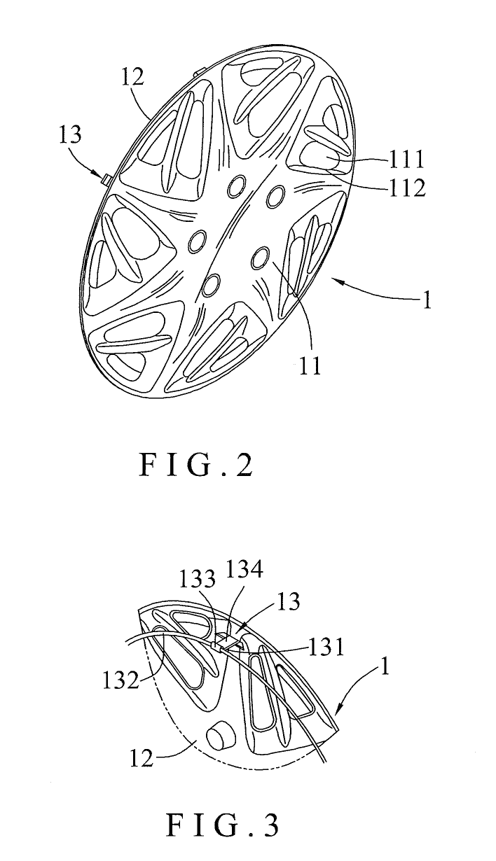

Referring to the drawings and initially to FIGS. 2 and 3, a wheel cover in accordance with the preferred embodiment of the present invention comprises a main body 1, a plurality of locking members 13 connected with the main body 1, and a metallic ring 132 locked onto and held by the locking members 13.

The main body 1 has an outer face 11 directed outward in packaging and an inner face 12 directed inward in packaging. The inner face 12 of the main body 1 is connected with the locking members 13. The outer face 11 of the main body 1 has a surface provided with a plurality of through holes 111 each having a predetermined pattern. Each of the through holes 111 of the main body 1 has an edge 112 which has a proper height and extends toward the inner face 12 of the main body 1.

The locking members 13 are arranged in an annular manner and are spaced from each other. Each of the locking members 13 is formed integrally on the inner face 12 of the main body 1. Each of the locking members 13 has a first end provided with a support portion 134 connected with the inner face 12 of the main body 1. The support portion 134 of each of the locking members 13 is bendable relative to the inner face 12 of the main body 1 to reduce a whole length of each of the locking members 13. Each of the locking members 13 has a second end provided with a retaining portion 133 for retaining the metallic ring 132. The retaining portion 133 of each of the locking members 13 has a side provided with a locking recess 131 locked onto the metallic ring 132. Thus, the support portion 134 of each of the locking members 13 is bendable relative to the inner face 12 of the main body 1 to move the retaining portion 133 of each of the locking members 13 toward the inner face 12 of the main body 1 so as to reduce the whole height of each of the locking members 13 relative to the inner face 12 of the main body 1.

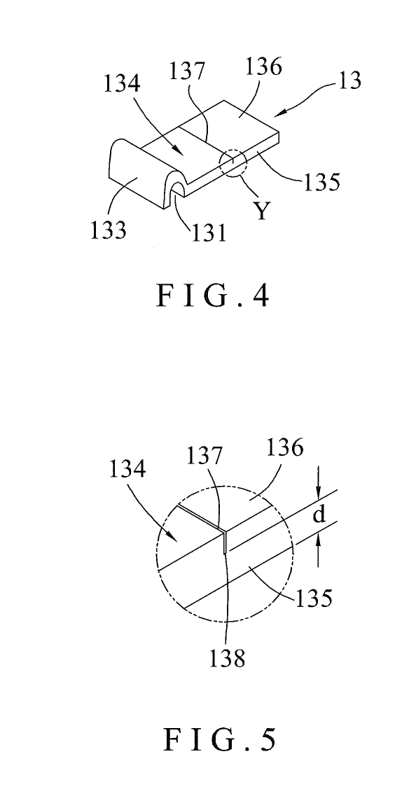

Referring to FIGS. 4 and 5, the support portion 134 of each of the locking members 13 has a first (or front) side 135 which is directed in a direction the same as that of the locking recess 131 and a second (or rear) side 136 which is directed in a direction opposite to that of the locking recess 131. The second side 136 of the support portion 134 of each of the locking members 13 has a surface provided with a folding seam 137 to make the support portion 134 of each of the locking members 13 bendable. The folding seam 137 of the support portion 134 of each of the locking members 13 has a depth of about 0.3 millimeter (mm). The folding seam 137 of the support portion 134 of each of the locking members 13 has a distal end 138 extended toward the first side 135 of the support portion 134 of each of the locking members 13, and a distance “d” between the distal end 138 of the folding seam 137 and the first side 135 of the support portion 134 of each of the locking members 13 is ranged between 0.7 mm and 0.8 mm.

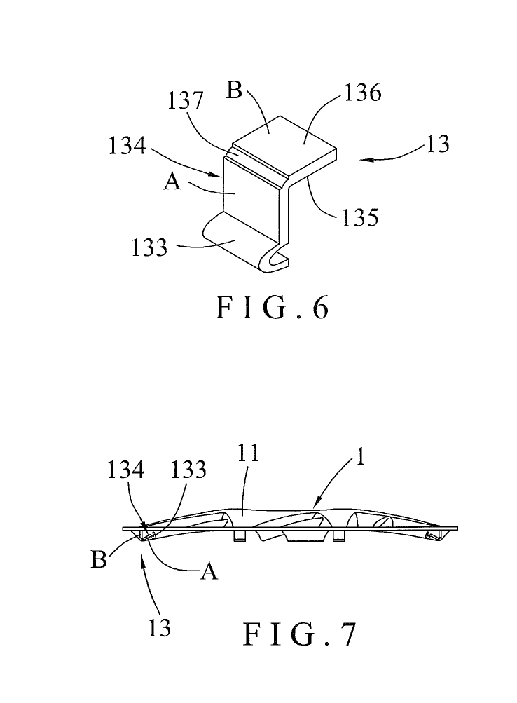

Referring to FIGS. 6 and 7 with reference to FIG. 3, each of the locking members 13 is divided by the folding seam 137 of the support portion 134 into a first part “B” and a second part “A”. The folding seam 137 of the support portion 134 of each of the locking members 13 is disposed between the first part “B” and the second part “A” of each of the locking members 13. The first part “B” of each of the locking members 13 is connected with the inner face 12 of the main body 1. The second part “A” of each of the locking members 13 is connected with the retaining portion 133 and is bendable relative to the first part “B”. Thus, each of the locking members 13 is bendable at the folding seam 137 with the second part “A” of each of the locking members 13 being bent toward the main body 1 to reduce the whole length of each of the locking members 13.

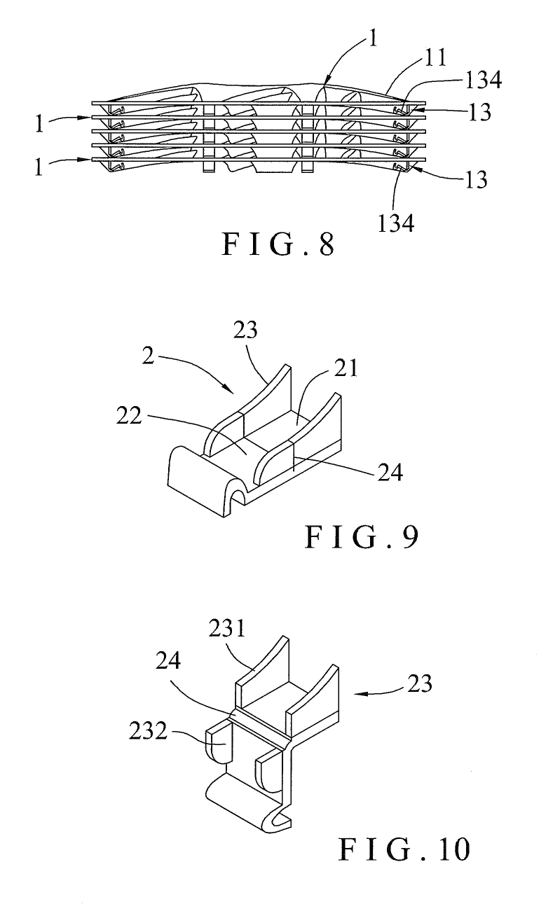

Referring to FIG. 8, the support portion 134 of each of the locking members 13 is bendable relative to the main body 1 to reduce the whole length of each of the locking members 13. Thus, when multiple wheel covers are stacked during packaging, the support portion 134 of each of the locking members 13 is bent to reduce the whole length of each of the locking members 13 so that the distance between the main bodies 1 of any two adjacent wheel covers is shortened so as to largely reduce the whole stacking height of the wheel covers and to largely reduce the packaging volume of the wheel covers.

In fabrication, each of the locking members 13 and the main body 1 are formed integrally by a plastic injection molding process. The folding seam 137 of the support portion 134 of each of the locking members 13 is also formed when each of the locking members 13 and the main body 1 are formed integrally during the plastic injection molding process. Alternatively, the folding seam 137 of the support portion 134 of each of the locking members 13 may be formed by other working manner after each of the locking members 13 and the main body 1 are formed integrally during the plastic injection molding process. In addition, each of the locking members 13 and the main body 1 are made of a plastic material with greater flexibility, such as polypropylene (PP). Thus, each of the locking members 13 will not be broken during bending and can be returned to its original state after bending.

In the preferred embodiment of the present invention, the depth and shape of the folding seam 137 of the support portion 134 of each of the locking members 13 may be changed according to the depth and shape of the support portion 134 of each of the locking members 13. Thus, the support portion 134 of each of the locking members 13 can be bent easily and smoothly by provision of the folding seam 137.

Referring to FIGS. 9 and 10, the support portion 22 of each of the locking members 2 is provided with two opposite reinforcement ribs 23 to reinforce the structural strength of the support portion 22 of each of the locking members 2. The second side 21 of the support portion 22 of each of the locking members 2 has a surface provided with a folding seam 24 to make the support portion 22 of each of the locking members 2 bendable. The folding seam 24 of the support portion 22 of each of the locking members 2 is extended through each of the reinforcement ribs 23. Thus, each of the reinforcement ribs 23 is divided by the folding seam 24 of the support portion 22 into a first part 231 and a second part 232.

Accordingly, each of the locking members 13 is bendable relative to the main body 1 so as to reduce the whole height of each of the locking members 13 relative to the main body 1. In addition, when multiple wheel covers are stacked, each of the locking members 13 is bent to reduce the whole length of each of the locking members 13 so that the distance between the main bodies 1 of any two adjacent wheel covers is shortened so as to largely reduce the whole stacking height of the wheel covers and to largely reduce the packaging volume of the wheel covers, thereby facilitating and decreasing the cost of packaging, storage and transportation of the wheel covers. Further, each of the locking members 13 and the main body 1 are formed integrally by a plastic injection molding process so as to decrease the cost of fabrication and assembly of the wheel cover. Further, the locking members 13 are not connected with the through holes 111 of the main body 1 so that the through holes 111 of the main body 1 will not be restricted by the locking members 13 and can have different patterns, thereby enhancing the aesthetic quality of the wheel cover.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A wheel cover, comprising:
a main body (1); and
a plurality of locking members (13) connected with the main body;
wherein the main body has an outer face (11) directed outward in packaging and an inner face (12) directed inward in packaging;
the outer face of the main body has a surface provided with a plurality of through holes (111) each having a predetermined pattern;
each of the locking members is formed integrally on the inner face of the main body;
each of the locking members has a first end provided with a support portion (134) connected with the inner face of the main body;
the support portion of each of the locking members is bendable relative to the inner face of the main body to reduce a whole length of each of the locking members;
each of the locking members has a second end provided with a retaining portion (133);
the support portion of each of the locking members is bendable relative to the inner face of the main body to move the retaining portion of each of the locking members toward the inner face of the main body so as to reduce a whole height of each of the locking members relative to the inner face of the main body.

2. The wheel cover of claim 1, wherein
the support portion of each of the locking members has a surface provided with a folding seam (137) to make the support portion of each of the locking members bendable;
each of the locking members is divided by the folding seam of the support portion into a first part (B) and a second part (A);
the folding seam of the support portion of each of the locking members is disposed between the first part and the second part of each of the locking members;
the first part of each of the locking members is connected with the inner face of the main body;
the second part of each of the locking members is connected with the retaining portion and is bendable relative to the first part; and
each of the locking members is bendable at the folding seam with the second part of each of the locking members being bent toward the main body to reduce the whole length of each of the locking members.

3. The wheel cover of claim 1, wherein
each of the locking members and the main body are made of a plastic material with greater flexibility; and
each of the locking members and the main body are made of polypropylene (PP).

4. The wheel cover of claim 1, wherein
the support portion (22) of each of the locking members (2) is provided with two opposite reinforcement ribs (23);
the support portion of each of the locking members has a surface provided with a folding seam (24) to make the support portion of each of the locking members bendable;
the folding seam of the support portion of each of the locking members is extended through each of the reinforcement ribs; and
each of the reinforcement ribs is divided by the folding seam of the support portion into a first part (231) and a second part (232).

5. A method for making a wheel cover, comprising:
forming a main body which has an outer face directed outward in packaging and an inner face directed inward in packaging;
forming the outer face of the main body with a plurality of through holes each having a predetermined pattern;
forming a plurality of locking members integrally on the inner face of the main body, with each of the locking members having a first end provided with a support portion connected with the inner face of the main body and a second end provided with a retaining portion; and
bending the support portion of each of the locking members to move the retaining portion of each of the locking members toward the inner face of the main body so as to reduce a whole height of each of the locking members relative to the inner face of the main body.

6. The method of claim 5, further comprising:
forming a folding seam in the support portion of each of the locking members to divide each of the locking members into a first part connected with the inner face of the main body and a second part connected with the retaining portion; and
bending the support portion of each of the locking members at the folding seam to bend the second part of each of the locking members toward the main body to reduce the whole length of each of the locking members.

7. The method of claim 5, further comprising:
forming two opposite reinforcement ribs on the support portion of each of the locking members;
forming a folding seam in the support portion of each of the locking members to divide each of the locking members into a first part connected with the inner face of the main body and a second part connected with the retaining portion;
extending the folding seam of the support portion of each of the locking members through each of the reinforcement ribs to divide each of the reinforcement ribs into a first part and a second part; and
bending the support portion of each of the locking members at the folding seam to bend the second part of each of the locking members toward the main body to reduce the whole length of each of the locking members.

8. A method for packaging multiple wheel covers, comprising:
forming a plurality of wheel covers each including a main body which has an outer face directed outward in packaging and an inner face directed inward in packaging;
forming the outer face of the main body of each of the wheel covers with a plurality of through holes each having a predetermined pattern;
forming a plurality of locking members integrally on the inner face of the main body of each of the wheel covers, with each of the locking members having a first end provided with a support portion connected with the inner face of the main body of each of the wheel covers and a second end provided with a retaining portion;
bending the support portion of each of the locking members to move the retaining portion of each of the locking members toward the inner face of the main body of each of the wheel covers so as to reduce a whole height of each of the locking members relative to the inner face of the main body of each of the wheel covers; and
stacking the wheel covers in a vertical manner.
